(19) United States
(12) Patent Application Publication
(10) Pub. No.: US 2011/0144997 A1
(43) Pub. Date: Jun. 16, 2011

(54) VOICE SYNTHESIS MODEL GENERATION DEVICE, VOICE SYNTHESIS MODEL GENERATION SYSTEM, COMMUNICATION TERMINAL DEVICE AND METHOD FOR GENERATING VOICE SYNTHESIS MODEL

(75) Inventor: Noriko Mizuguchi, Kanagawa (JP)

(73) Assignee: NTT DOCOMO, INC, Tokyo (JP)

(21) Appl. No.: 13/003,701

(22) PCT Filed: Jul. 7, 2009
(86) PCT No.: PCT/JP2009/062341

§ 371 Date: Mar. 2, 2011

(30) Foreign Application Priority Data
Jul. 11, 2008 (JP) 2008-181683

(51) Int. Cl. G10L 13/00

(52) U.S. Cl. 704/258; 704/E13.001

(57) ABSTRACT

A voice synthesis model generation device, a voice synthesis model generation system, a communication terminal device, and a method for generating a voice synthesis model all of which are capable of preferably acquiring a user's voice. A voice synthesis model generation system is configured to include a mobile communication terminal device and a voice synthesis model generation device. The mobile communication terminal device includes a characteristic amount extraction portion that extracts a characteristic amount of input voice, and a text data acquisition portion that acquires text data from the voice. The voice synthesis model device includes a voice synthesis model generation portion that generates a voice synthesis model based on the characteristic amount and the text data that are acquired by a learning information acquisition portion, an image information generation portion that generates image information based on a parameter based on the characteristic amount and the text data, and an information output portion that transmits the image information to the mobile communication terminal device.

### TECHNICAL FIELD

The present invention relates to a voice synthesis model generation device, a voice synthesis model generation system, a communication terminal device, and a method for generating a voice synthesis model.

### BACKGROUND ART

Conventionally, technologies for generating a voice synthesis model have been known. The voice synthesis model is information to be used for creating voice data corresponding to a text (character string) input. As a method for synthesizing voice by using the voice synthesis model, Patent Document 1 (Patent Document 1: Japanese Unexamined Patent Application Publication No. 2003-295880) describes one method by which the character string input is analyzed and voice data corresponding to the text is combined with reference to the voice synthesis model to create voice data.

### SUMMARY OF INVENTION

### Problems to be Solved by the Invention

Meanwhile, for generating a voice synthesis model, voice data of any target person (user) needs to be collected in advance. For collecting such data, it is required, for example, to use a studio and record the voice of any target person over long hours (several hours to tens of hours). At that time, there is a risk that an action that the user simply inputs (records) the voice over long hours, for example, based on a scenario, lowers the user's motivation to input the voice.

The present invention has been devised to solve the above problems, and aims to provide a voice synthesis model generation device, a voice synthesis model generation system, a communication terminal device, and a method for generating a voice synthesis model all of which are capable of preferably acquiring a user's voice.

### MEANS FOR SOLVING THE PROBLEMS

To achieve the above objective, a voice synthesis model generation device according to the present invention includes learning information acquisition means for acquiring text data corresponding to a characteristic amount of a user's voice and text data corresponding to the voice; voice synthesis model generation means for generating a voice synthesis model by carrying out learning based on the characteristic amount and the text data that are acquired by the learning information acquisition means; parameter generation means for generating a parameter indicating a degree of learning in terms of the voice synthesis model generated by the voice synthesis model generation means; image information generation means for generating image information for displaying an image to a user corresponding to the parameter generated by the parameter generation means; and image information output means for outputting the image information generated by the image information generation means.

With such a configuration, a voice synthesis model is generated based on the characteristic amount of voice and text data and a parameter indicating a degree of learning in terms of the voice synthesis model is generated. Then, image information for displaying an image to a user is generated corresponding to the parameter and the image information is output. In this way, the user who inputs voice can recognize a degree of learning in terms of the voice synthesis model as visualized image, so that it is possible to gain a sense of achievement to input the voice, and the user's motivation to input the voice improves. As a result, it is possible to acquire the user's voice preferably.

In order to acquire the characteristic amount, it is preferable to further include request information generation means for generating and outputting request information that makes the user input the voice based on the parameter generated by the parameter generation means. With such a configuration, the voice input by the user becomes appropriate one for learning to generate the voice synthesis model.

It is preferable that word extraction means for extracting a word from the text data acquired by the learning information acquisition means be further included and the parameter generation means generate the parameter indicating the degree of learning in terms of the voice synthesis model corresponding to an accumulated word count of the word extracted by the word extraction means. With such a configuration, the parameter is generated corresponding to the accumulated word count, so that the user can recognize that the word count is increasing by looking at image information generated corresponding to the parameter. In this way, it is possible to further gain a sense of achievement to input the voice. As a result, it is possible to acquire the user's voice preferably.

It is also preferable that the image information be information for displaying a character image. With such a configuration, the character image to be output to the user becomes, for example, larger corresponding to the parameter, therefore, it is possible to visually impress the user more than a case, for example, that a value and the like are displayed as an image. In this way, it is possible for the user to further gain a sense of achievement, and the user's motivation to input the voice further improves. As a result, it is possible to acquire the user's voice preferably.

It is also preferable that the voice synthesis model generation means generate the voice synthesis model for each user. With such a configuration, it is possible to generate the voice synthesis model corresponding to each user, and for each person to use the voice synthesis model by individuals.

It is also preferable that the voice characteristic amount be context data in which the voice is labeled in a voice unit and data about a voice wave that shows characteristics of the voice. With such a configuration, it is possible to reliably generate the voice synthesis model.

To achieve the above objective, a voice synthesis model generation system according to the present invention includes a communication terminal device with a communication function and a voice synthesis model generation device capable of communicating with the communication terminal device, in which the communication terminal device includes voice input means for inputting a user's voice; learning information transmission means for transmitting voice information composed of the voice input with the voice input means and a characteristic amount of the voice, and text data corresponding to the voice, to the voice synthesis model generation device; image information reception means for receiving image information for displaying an image to a user from the voice synthesis model generation device, once the voice information transmission means transmits the voice information and the text data; and display means for displaying the image information received by the image information reception means; and the voice synthesis model generation device includes learning information acquisition means for acquiring the characteristic amount of the voice by receiving the voice information transmitted from the communication terminal device, and for acquiring the text data by receiving the text data transmitted by the communication terminal device; voice synthesis model generation means for generating the voice synthesis model by carrying out learning based on the characteristic amount and the text data that are acquired by the learning information acquisition means; parameter generation means for generating a parameter indicating a degree of learning in terms of the voice synthesis model generated by the voice synthesis model generation means; image information generation means for generating the image information corresponding to the parameter generated by the parameter generation means; and image information output means for transmitting the image information generated by the image information generation means to the communication terminal device.

With such a configuration, acquisition of the voice is made with the communication terminal device and voice information composed of the voice and the characteristic amount of the voice and text data corresponding to the voice, are received at the voice synthesis model generation device, the voice synthesis model is generated based on the characteristic amount and the text data. Then, the parameter indicating a degree of learning in terms of the voice synthesis model is generated. Corresponding to the parameter, the image information for displaying image to a user is generated and transmitted from the voice synthesis model generation device to the communication terminal device. In this way, the user who inputs voice can recognize a degree of learning in terms of the voice synthesis model as visualized image, so that it is possible to gain a sense of achievement about inputting the voice, and the user's motivation to try to input the voice improves. As a result, it is possible to acquire the user's voice preferably. Furthermore, since the voice is acquired by the communication terminal device, a facility such as a studio is unnecessary and it is possible to easily acquire the voice.

It is preferable that the communication terminal device further include characteristic amount extraction means for extracting the characteristic amount of the voice from the voice input with the voice input means. There is a case that voice transmitted from the communication terminal device is deteriorated through codec and a communication path, and there is a risk that generating the voice synthesis model from the voice deteriorates the quality of the voice synthesis model. However, with the above configuration, since the characteristic amount necessary for generating the voice synthesis model is extracted by the communication terminal device and the characteristic amount is to be sent, it is possible to generate the voice synthesis model with high accuracy.

It is also preferable to further include text data acquisition means for acquiring text data corresponding to the voice from the voice input with the voice input means. With such a configuration, the user is not required to input the voice corresponding to the text data, so that it is possible to save the user's trouble.

Meanwhile, the present invention can be described as an invention of the voice synthesis model generation system described above, in addition to that, it can be described also as an invention of the communication terminal device included in the voice synthesis model generation system as below. The communication terminal device included in the voice synthesis model generation system has a novel configuration and is equivalent to the present invention. Therefore, it exhibits performance and effect similar to that of the voice synthesis model generation system.

That is, a communication terminal device according to the present invention, is the communication terminal device with a communication function, including voice input means for inputting a user's voice; characteristic amount extraction means for extracting a characteristic amount of the voice from the voice input with the voice input means; text data acquisition means for acquiring text data corresponding to the voice; learning information transmission means for transmitting the voice characteristic amount extracted by the characteristic amount extraction means and the text data acquired by the text data acquisition means, to a voice synthesis model generation device capable of communicating with the communication terminal device; image information reception means for receiving image information for displaying an image to the user from the voice synthesis model generation device, once the learning information transmission means transmits the characteristic amount and the text data; and display means for displaying the image information received by the image information reception means.

The present invention can be described as, in addition to the inventions of the voice synthesis model generation device, the voice synthesis model generation system and the communication terminal device as described above, an invention of a method for generating a voice synthesis model. Although its category is different, it is substantially the same invention and exhibits similar performance and effects.

Specifically, a method for generating a voice synthesis model according to the present invention includes a learning information acquisition step of acquiring a characteristic amount of a user's voice and text data of the voice; a voice synthesis model generation step of generating a voice synthesis model by carrying out learning based on the characteristic amount and the text data that are acquired in the learning information acquisition step; a parameter generation step of generating a parameter indicating a degree of learning in terms of the voice synthesis model generated in the voice synthesis model generation step; an image information generation step of generating image information for displaying, to a user, an image corresponding to the parameter generated in the parameter generation step; and an image information output step of outputting the image information generated in the image information generation step.

Furthermore, a method for generating a voice synthesis model according to the present invention is a method performed by a voice synthesis model generation system including a communication terminal device with a communication function and a voice synthesis model generation device capable of communicating with the communication terminal device, in which the communication terminal device includes a voice input step of inputting a user's voice; a learning information transmission step of transmitting voice information composed of the voice input in the voice input step or a characteristic amount of the voice, and text data corresponding to the voice, to the voice synthesis model generation device; an image information reception step of receiving image information for displaying an image to the user from the voice synthesis model generation device, once the voice information and the text data are transmitted in the voice information transmission step; and a display step of displaying the image information received in the image information reception step, and the voice synthesis model generation device includes a learning information acquisition step of acquiring the characteristic amount of voice by receiving the voice information transmitted from the communication terminal device, and of acquiring the text data by receiving the text data transmitted from the communication terminal device; a voice synthesis model generation step of generating a voice synthesis model by carrying out learning based on the characteristic amount and the text data acquired in the learning information acquisition step; a parameter generation step of generating a parameter indicating a degree of learning in terms of the voice synthesis model generated in the voice synthesis model generation step; an image information generation step of generating the image information corresponding to the parameter generated in the parameter generation step; and an image information output step of transmitting the image information generated in the image information generation step to the communication terminal device.

Furthermore, a method for generating a voice synthesis model according to the present invention is a method performed by a communication terminal device with a communication function, including a voice input step of inputting a user's voice; a characteristic amount extraction step of extracting a characteristic amount of the voice from the voice input in the voice input step; a text data acquisition step of acquiring text data corresponding to the voice; a learning information transmission step of transmitting the voice characteristic amount extracted in the characteristic amount extraction step and the text data acquired in the text data acquisition step, to a voice synthesis model generation device capable of communicating with the communication terminal device; an image information reception step of receiving image information for displaying an image to the user from the voice synthesis model generation device, once the characteristic amount and the text data are transmitted in the learning information transmission step; and a display step of displaying the image information received in the image information reception step.

### EFFECT OF THE INVENTION

According to the present invention, the user can visually recognize a degree of learning in terms of the voice synthesis model generated from the input voice, so that it is possible to prevent the user's motivation for voice input from dropping, due to an action that the user simply inputs the voice for long hours, and to acquire the user's voice preferably.

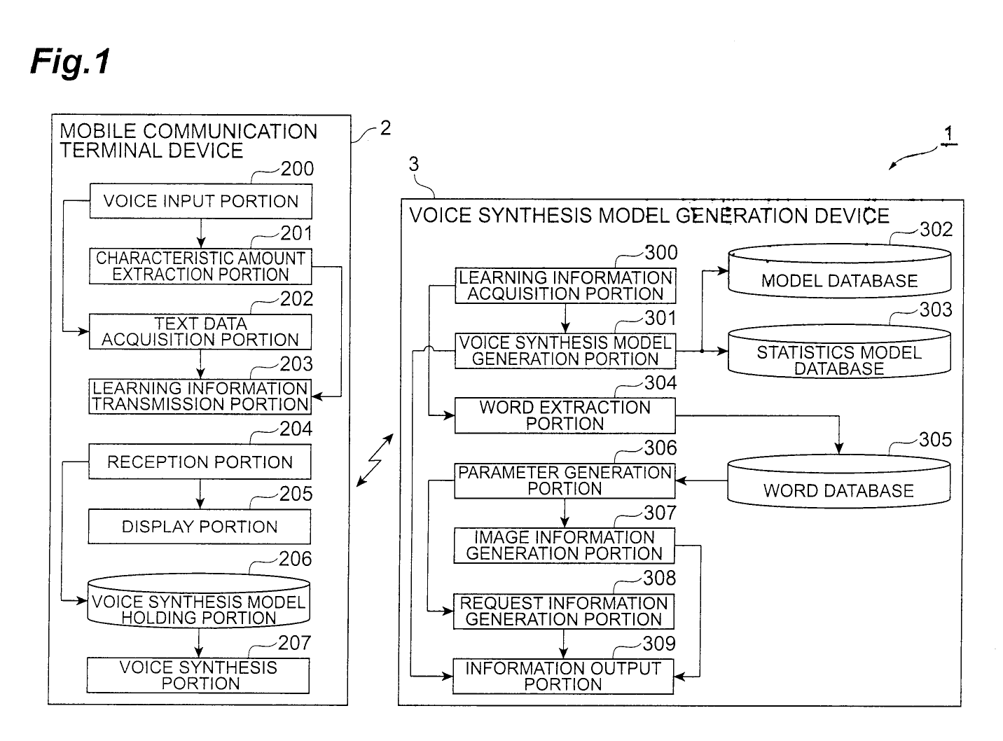

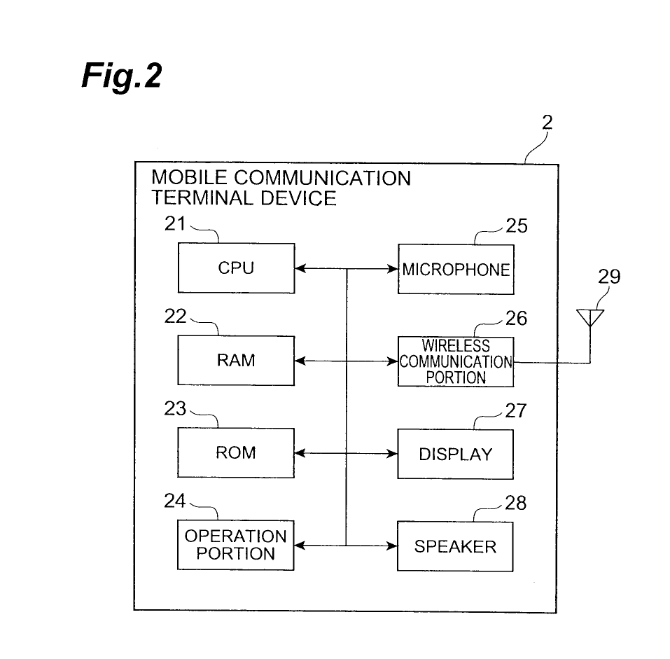

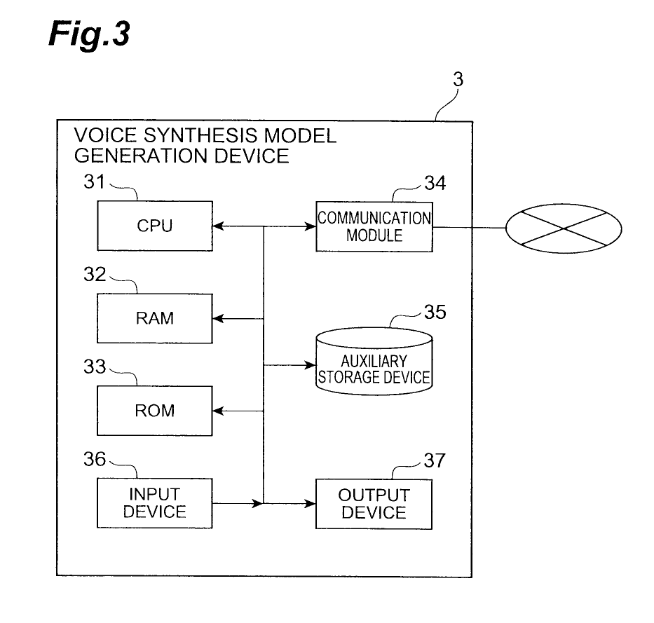

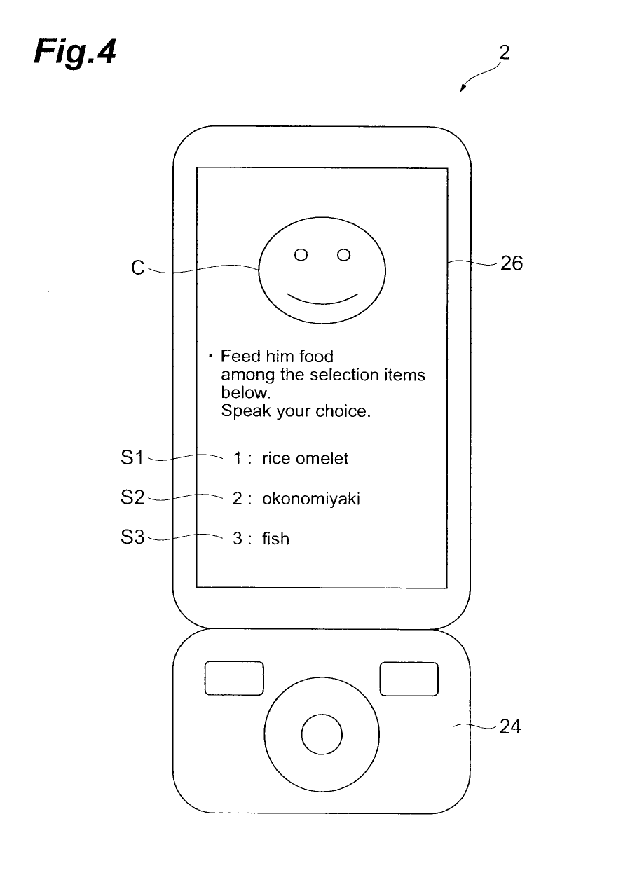

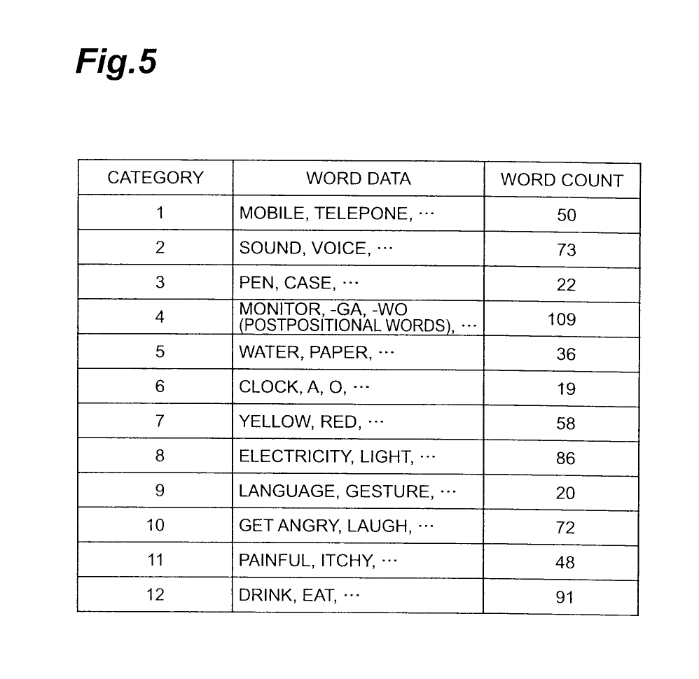

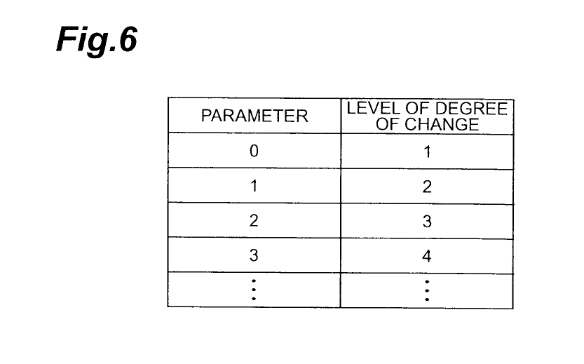

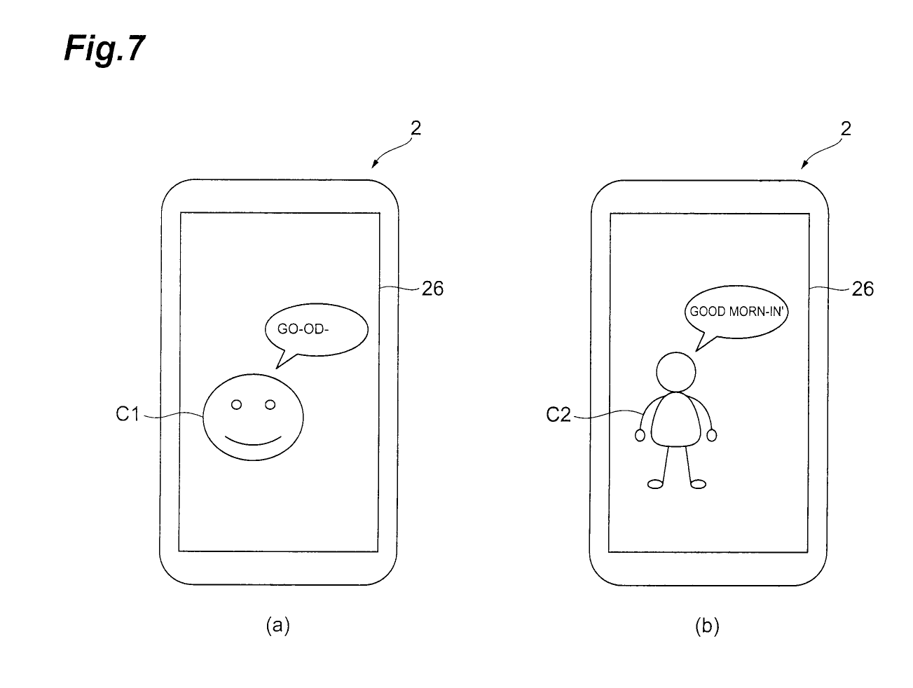

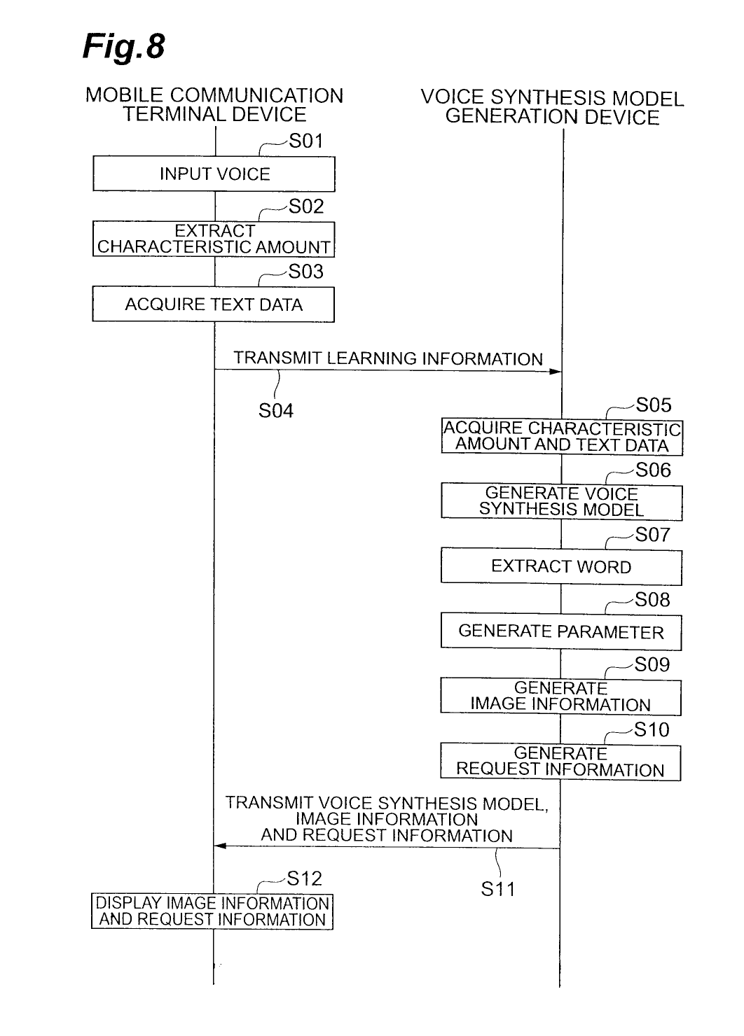

### BRIEF DESCRIPTION OF DRAWINGS

[FIG. 1] FIG. 1 is a view showing a configuration of a voice synthesis model generation system according to an embodiment of the present invention.

[FIG. 2] FIG. 2 is a view showing a hardware configuration of a mobile communication terminal device.

[FIG. 3] FIG. 3 is a view showing a hardware configuration of a voice synthesis model generation device.

[FIG. 4] FIG. 4 is a view showing an example in which image information and request information are displayed on a display.

[FIG. 5] FIG. 5 is a view showing an example of a table holding word data.

[FIG. 6] FIG. 6 is a view showing an example of a table where a parameter is corresponded to a level indicating a degree of change in an image.

[FIG. 7] FIG. 7 shows examples in which a character image displayed on the display of the mobile communication terminal device changes corresponding to a level indicating a degree of change in an image.

[FIG. 8] FIG. 8 is a sequence diagram showing processing in the mobile communication terminal device and the voice synthesis model generation device.

### BEST MODES FOR CARRYING OUT THE INVENTION

The following describes, with reference to drawings, the details of preferred embodiments of a voice synthesis model generation device, a voice synthesis model generation system, a communication terminal device and a method for voice synthesis model generation according to the present invention. It should be noted that in the description of drawings, the same elements are labeled with the same reference numerals and redundant description is omitted.

FIG. 1 shows a configuration of a voice synthesis model generation system according to an embodiment of the present invention. As shown in FIG. 1, a voice synthesis model generation system 1 is configured to include a mobile communication terminal device (communication terminal device) 2 and a voice synthesis model generation device 3. The mobile communication terminal device 2 and the voice synthesis model generation device 3 can transmit and receive information each other through mobile communication. Only one mobile communication terminal device 2 is shown in FIG. 1, but an infinite number of mobile communication terminal devices 2 are usually included in the voice synthesis model generation system 1. Furthermore, the voice synthesis model generation device 3 may be configured by a single device or by a plurality of devices.

The voice synthesis model generation system 1 is a system capable of generating a voice synthesis model to a user of the mobile communication terminal device 2. The voice synthesis model is information to be used for creating a user's voice data corresponding to the input text. The voice data synthesized by using the voice synthesis model can be used, for example, at a time when an electronic mail is read, at a time when messages received in one's absence are reproduced, on the mobile communication terminal device 2, or on a weblog or the web.

The mobile communication terminal device 2 is a communication terminal device, for example, a cell-phone handset that performs wireless communication with a base station covering a wireless area where the handset exists, and receives a communication service or a packet communication service in response to an operation by the user. Furthermore, the mobile communication terminal device 2 is capable of using an application that uses the packet communication service and the application is updated by data transmitted from the voice synthesis model generation device 3. Management of the application may be performed not by the voice synthesis model generation device 3, but by a device separately provided. It should be noted that the application according to the present embodiment performs a screen display and examples thereof include a game of a development series where a command input can be carried out by a user's voice. More specific examples include the one where a character to be displayed through the application by inputting the user's voice is grown up (the character's appearance or the like changes).

The voice synthesis model generation device 3 is a device for generating the voice synthesis model based on information transmitted from the mobile communication terminal device 2 about the user's voice. The voice synthesis model generation device 3 exists on a mobile communication network and is managed by a service operator that provides a service of generating the voice synthesis model.

FIG. 2 is a view showing a hardware configuration of the mobile communication terminal device 2. As shown in FIG. 2, the mobile communication terminal device 2 is configured by hardware, such as a CPU (Central Processing Unit) 21, a RAM (Random Access Memory) 22, a ROM (Read Only Memory) 23, an operation portion 24, a microphone 25, a wireless communication portion 26, a display 27, a speaker 28 and an antenna 29. Operation of such configuration elements enables the mobile communication terminal device 2 to fulfill its functions to be described below.

FIG. 3 is a view showing a hardware configuration of a voice synthesis model generation device 3. As shown in FIG. 3, the voice synthesis model generation device 3 is configured as a computer including hardware, such as a CPU 31, a RAM 32 and a ROM 32 that serve as a main storage device, a communication module 34 that is a data receiving and transmitting device such as a network card, an auxiliary storage device 35 such as a hard disk, an input device 36 for inputting information to the voice synthesis model generation device 3, such as a keyboard, and an output device 37 for outputting information, such as a monitor. Operation of such configuration elements enables the voice synthesis model generation device 3 to fulfill functions thereof below.

Subsequently, description will be given on the functions of the mobile communication terminal device 2 and the voice synthesis model generation device 3.

With reference to FIG. 1, description will be given on the mobile communication terminal device 2. As shown in FIG. 1, the mobile communication terminal device 2 includes a voice input portion 200, a characteristic amount extraction portion 201, a text data acquisition portion 202, a learning information transmission portion 203, a reception portion 204, a display portion 205, a voice synthesis model holding portion 206, and a voice synthesis portion 207.

The voice input portion 200 is the microphone 25 and is voice input means for inputting a user's voice. The voice input portion 200 inputs the user's voice, for example, as a command input to the above application. The voice input portion 200 removes noise (interference) by passing the input voice through a filter, and outputs the voice input by the user to the characteristic amount extraction portion 201 and to the text data acquisition portion 202, as voice data.

The characteristic amount extraction portion 201 extracts a characteristic amount of voice from the voice data received from the voice input portion 200. The characteristic amount of the voice is quantification of voice qualities, such as high and low pitches, speeds, and accents of the voice, and specifically, for example, context data in which the voice is labeled in a voice unit and data about a voice wave that shows characteristics of the voice. The context data is a context label (phoneme string) in which voice data is divided (labeled) into the voice unit such as phonemes. The voice unit is “phonemes”, “words”, “segments” or the like, in which the voice is separated in accordance with a given rule. Specific examples of a context label factor include preceding, present and succeeding phonemes, a mora position in an accent phrase of the present phoneme, preceding, present and succeeding parses/conjugational forms/conjugational types, preceding, present and succeeding accent phrase lengths/accent types, a position of the present accent phrase/presence or absence of a pause with preceding and succeeding ones, preceding, present and succeeding breath group lengths, a position of the present breath group, and a sentence length. Voice wave data is logarithmic fundamental frequency and mel-cepstrum. The logarithmic fundamental frequency represents a pitch of the voice and is extracted by extracting a fundamental frequency parameter from the voice data. The mel-cepstrum represents quality of the voice and is extracted by analyzing the voice data through the mel-cepstrum. The characteristic amount extraction portion 201 outputs the characteristic amount thus extracted to the learning information transmission portion 203.

The text data acquisition portion 202 is text data acquisition means for acquiring text data, corresponding to the voice, from the voice data received by the voice input portion 200. The text data acquisition portion 202 analyzes (recognizes voice) input voice data and acquires the text data (character string) that corresponds in content with the voice input by a user. The text data acquisition portion 202 outputs the text data acquired to the learning information transmission portion 203. It should be noted that the text data may be acquired from the characteristic amount of voice extracted by the characteristic amount extraction portion 201.

The learning information transmission portion 203 is learning information transmission means for transmitting the characteristic amount received by the characteristic amount extraction portion 201 and the text data received by the text data acquisition portion 202, to the voice synthesis model generation device 3. The learning information transmission portion 203 transmits the characteristic amount and the text data through XML over HTTP, SIP or the like, to the voice synthesis model generation device 3. Here, between the mobile communication terminal device 2 and the voice synthesis model generation device 3, user authentication is carried out by using, for example, SIP or IMS.

The reception portion 204 is reception means (image information reception means) for receiving image information, request information and the voice synthesis model from the voice synthesis model generation device 3, once the learning information transmission portion 203 transmits the characteristic amount and the text data to the voice synthesis model generation device 3. The image information is information for displaying an image to a user on the display 27. The request information is, for example, information to urge the user to input a voice, or information to input, such as sentences and words, and image (text) corresponding to the request information is displayed on the display 27. The image information or the request information is output by using the above application. Furthermore, the voice data corresponding to the request information may be output from the speaker 28. The reception portion 204 outputs the image information and the request information thus received to the display portion 205, and outputs the voice synthesis model to a voice synthesis holding portion 206.

The display portion 205 is display means for displaying the image information or the request information received from the reception portion 204. The display portion 205 displays, when an application is activated, the image information and the request information on the display 27 of the mobile communication terminal device 2. FIG. 4 is a view showing an example in which the image information and the request information are displayed on the display 27. As shown in the FIG, the image information is displayed as an image of a character C in the upper side of the display 27, while the request information is displayed as messages for demanding a user to input a voice, for example, three selection items S1 to S3. The user speaks any of the selection items S1 to S3 displayed on the display 27 and the voice thus spoken is input with the voice input portion 200.

The voice synthesis model holding portion 206 holds the voice synthesis model received from the reception portion 204. Upon receiving information on the voice synthesis model from the reception portion 204, the voice synthesis model holding portion 206 processes to update an existing voice synthesis model.

The voice synthesis portion 207 synthesizes voice data with reference to the voice synthesis model held in the voice synthesis model holding portion 206. A method for synthesizing the voice data to be used is a method conventionally well known. Specifically, for example, upon being given an instruction to synthesize from a user who inputs text (characteristic string) with the operation portion (keyboard) 24 of the mobile communication terminal device 2, the voice synthesis portion 207 refers to the voice synthesis model holding portion 206, stochastically predicts a sonically characteristic amount (logarithmic fundamental frequency and mel-cepstrum) corresponding to a phoneme string (context label) of the text input from the held voice synthesis model, synthesizes to generate voice data corresponding to the input text. The voice synthesis portion 207 outputs the synthesized voice data to, for example, the speaker 28. It should be noted that the voice data generated in the voice synthesis portion 207 is also used in the application.

Subsequently, description will be given on the voice synthesis model generation device 3. As shown in FIG. 1, the voice synthesis model generation device 3 includes a learning information acquisition portion 300, a voice synthesis model generation portion 301, a model database 302, a statistics model database 303, a word extraction portion 304, a word database 305, a parameter generation portion 306, an image information generation portion 307, a request information generation portion 308 and an information output portion 309.

The learning information acquisition portion 300 is learning information acquisition means for acquiring a characteristic amount and text data by receiving them from the mobile communication terminal device 2. The learning information acquisition portion 300 outputs the characteristic amount and the text data that are acquired by receiving from the mobile communication terminal device 2, to the voice synthesis model generation portion 301, and outputs the text data to the word extraction portion 304.

The voice synthesis model generation portion 301 is voice synthesis model generation means for generating a voice synthesis model by carrying out learning based on the characteristic amount and the text data that are received from the learning information acquisition portion 300. The generation of the voice synthesis model is carried out by a conventionally well-known method. Specifically, for example, the voice synthesis model generation portion 301 generates, based on learning of Hidden Markov Model: HMM, a voice synthesis model for each user of the mobile communication terminal device 2. The voice synthesis model generation portion 301 uses HMM that is a kind of a stochastically model to model the sonically characteristic amount (logarithmic fundamental frequency and mel-cepstrum) of a voice unit (context label) such as a phoneme. The voice synthesis model generation portion 301 carries out repeat learning of the logarithmic fundamental frequency and the mel-cepstrum. The voice synthesis model generation portion 301 decides and models, based on models each generated in terms of the logarithmic fundamental frequency and the mel-cepstrum, a state continuation length (phonologic continuation length) that shows a rhythm or a tempo of the voice, from a state distribution (gauss distribution). Then, the voice synthesis model generation portion 301 synthesizes HMMs of the logarithmic fundamental frequency and the mel-cepstrum with the model of the state continuation length to generate a voice synthesis model. The voice synthesis model thus generated is output to the model database 302 and the statistics model database 303.

The model database 302 holds the voice synthesis model received from the voice synthesis model generation portion 301 for each user. The model database 302, upon receiving information on a new voice synthesis model from the voice synthesis model generation portion 301, processes to update the existing voice synthesis model.

The statistics model database 303 collectively holds all voice synthesis models for the user of the mobile communication terminal devices 2 received from the voice synthesis model generation portion 301. The information about the voice synthesis models to be held in the statistics model database 303 is, for example, processed by a statistics model generation portion to generate an average model of all the users or an average model in each age group of the user, which is used to interpolate a deficient model of the voice synthesis model for an individual user.

The word extraction portion 304 is word extraction means for extracting a word from the text data received from the learning information acquisition portion 300. Upon receiving the text data from the learning information acquisition portion 300, the word extraction portion 304 refers a dictionary database (not shown) that holds word information for specifying the word by a method such as a morphological analysis, and extracts the word from the text data, based on a degree of correspondence between the text data and the word information. The word indicates the minimum unit of a sentence configuration, and includes an independent word, such as “Mobile phone” and a dependent word, such as “-wo” (postpositional word). The word extraction portion 304 outputs word data indicating the extracted word for each user in the word database 305.

The word database 305 holds the word data received from the word extraction portion 304 for each user. The word database 305 holds a table shown in FIG. 5. FIG. 5 is a view showing an example of the table where the word data is held. As shown in FIG. 5, in the table of the word data, “word data” each stored in 12 categories divided by a given rule is held to correspond to “word count” of the word data. For example, in the category 1, the words such as “Mobile phone” and “Voice” are held and an accumulated word count in the category is “50”. It should be noted that the category in which the word is stored is decided by a conventional method, including a decision tree of a spectrum portion, a decision tree of the fundamental frequency, and a decision tree of the state continuation length model.

The parameter generation portion 306 is parameter generation means for generating a parameter indicating a degree of learning in terms of the voice synthesis model, corresponding to the accumulated word count in the word database 305 where the word extracted by the word extraction portion 304 is held. The above degree of learning is a degree (of accuracy of the voice synthesis model) indicating to what extent the voice synthesis model can reproduce a user's voice. The parameter generation portion 306 calculates the accumulated word count from the word count in each category of the word database 305, and generates a parameter indicating a degree of learning in terms of the voice synthesis model, which is proportional to the accumulated word count, for each user. The parameter is shown as a value such as 0 and 1, and indicates that as the value becomes larger, the degree of learning becomes higher. Calculating the parameter corresponding to the accumulated word count is because that an increase in the word count of each category has a direct relationship with improvement of the accuracy of the voice synthesis model. The parameter generation portion 306 outputs the parameter thus generated to the image information generation portion 307 and the request information generation portion 308. It should be noted that the parameter includes information that can specify the word count in each category. Furthermore, as the input of the voice data increases, the accuracy of the voice synthesis model improves and the reproducibility of the user's voice increases, but it is possible to define the voice data in a degree in which an improvement rate statistically becomes sluggish, as maximum.

The image information generation portion 307 is image information generation means for generating image information for displaying an image to a user of the mobile communication terminal device 2, corresponding to the parameter output from the parameter generation portion 306. The image information generation portion 307 generates image information for displaying a character image to be used in an application. The image information generation portion 307 holds a table shown in FIG. 6. FIG. 6 is a view showing an example of a table where a parameter is corresponded to a level showing a degree of change in the image. As shown in FIG. 6, when the parameter is “0”, the level is “1” and when the parameter is “3”, the level is “4”. The image information generation portion 307 generates image information corresponding to the level showing a degree of change in the image, and outputs the image information to the information output portion 309.

Here, an example will be given in FIG. 7, where a character image displayed on the display 27 of the mobile communication terminal device 2 changes corresponding to the degree of change in the image. FIG. 7(a) is a view showing a character image C1 corresponding to the level 1, and FIG. 7(b) is a view showing a character image C2 corresponding to the level 3. As shown in FIGS. 7(a) and 7(b), an outline of the character image C1 is unclear in the level 1, while the outline of the character image C2 is clear in the level 3. In this way, according to the level corresponding to the parameter, the character image grows (changes). Furthermore, phrases displayed in a speech balloon of the character images C1 and C2 are displayed to be spoken more fluently, as the level increases. That is, as learning of the voice synthesis model advances by the user's voice, the character to be displayed through the application grows accordingly.

The request information generation portion 308 is request information generation means for generating request information to make the user input the voice so as to acquire a characteristic amount based on the parameter generated by the parameter generation portion 306. The request information generation portion 308 compares, based on the parameter, the word count of each category that are held in the word database, specifies a category having the fewer word count than other categories, and calculates the word corresponding to the category. Specifically, as shown in FIG. 5, for example, when the word count held in the category “6” is fewer than that in other categories, the request information generation portion 308 calculates a plurality of words corresponding to the category “6”. Then the request information generation portion 308 generates request information indicating the calculated words, and outputs them to the information output portion 309.

The information output portion 309 is information output means (image information output means) for transmitting the voice synthesis model generated by the voice synthesis model generation portion 301; the image information output from the image information generation portion 307; and the request information output from the request information generation portion 308; to the mobile communication terminal device 2. The information output portion 309 transmits the voice synthesis model, the image information and the request information, when a new parameter is generated by the parameter generation portion 306.

Subsequently, with reference to FIG. 8, description will be given on processing (voice synthesis model generation method) to be carried out in the voice synthesis model generation system 1 according to the present embodiment. FIG. 8 is a sequence diagram showing processing in the mobile communication terminal device 2 and the voice synthesis model generation device 3.

As shown in FIG. 8, in the mobile communication terminal device 2, first voice corresponding to a display through the application is input with the voice input portion 200 by a user (S01, voice input step). Then, the characteristic amount of the voice is, based on the voice data input with the voice input portion 200, extracted by the characteristic amount extraction portion 201 (S02). Furthermore, based on the voice data input with the voice input portion 200, the text data corresponding to the voice is acquired by the text data acquisition portion 202 (S03). Learning information including the voice characteristic amount and the text data is transmitted by the learning information transmission portion 203 to the voice synthesis model generation device 3 (S04, learning information transmission step).

In the voice synthesis model generation device 3, once the learning information is received by the learning information acquisition portion 300 from the mobile communication terminal device 2, the characteristic amount and the text data are acquired. (S05, learning information acquisition step) Next, a voice synthesis model is generated by the voice synthesis model generation portion 301, based on the characteristic amount and the text data thus acquired (S06, voice synthesis model generation step). Furthermore, a word is extracted by the word extraction portion 304 based on the acquired text data (S07). Then, a parameter indicating a degree of learning in terms of the voice synthesis model is generated by the parameter generation portion 306, based on the accumulated word count of the extracted word (S08, parameter generation step).

Subsequently, image information corresponding to the parameter for displaying the image to the user of the mobile communication terminal device 2 is generated by the image information generation 307 based on the generated parameter (S09). Furthermore, request information to let the user of the mobile communication terminal device 2 input the voice is generated to acquire the characteristic amount by the request information generation portion 308 based on the generated parameter (S10). The voice synthesis model, the image information and the request information thus generated are transmitted by the information output portion 309 from the voice synthesis model generation portion 301 to the mobile communication terminal device 2 (S11, information output step).

In the mobile communication terminal device 2, the voice synthesis model, the image information and the request information are received by the reception portion 204, and the voice synthesis model is held in the voice synthesis model holding portion 206, while the image information and the request information are displayed on a display by the display portion 205 (S12, display step). The user of the mobile communication terminal device 2 inputs the voice in accordance with the request information displayed on the display 27. When the voice is input, the processing returns to Step S01 and the following processing is repeated. The foregoing is the processing carried out in the voice synthesis model generation system 1 according to the present embodiment.

With such a configuration, a voice synthesis model is generated based on a characteristic amount of voice and text data, and a parameter indicating a degree of learning in terms of the voice synthesis model is generated. Then, image information for displaying an image to a user is generated corresponding to the parameter, and the image information is output. In this way, the user who inputs voice can recognize a degree of learning in terms of the voice synthesis model as a visualized image, so that it is possible to gain a sense of achievement to input the voice, and the user's motivation to try to input the voice improves.

In order to acquire the characteristic amount based on the parameter generated by the parameter generation portion 306 in the voice synthesis model generation device 3, the request information to let the user input the voice is generated and transmitted to the mobile communication terminal device 2, so that the voice input by the user becomes appropriate for learning to generate the voice synthesis model.

The parameter generation portion 306 generates, based on the accumulated word count of the word extracted by the word extraction portion 304, a parameter indicating a degree of learning in terms of the voice synthesis model. In this way, the parameter is generated corresponding to the accumulated word count, therefore, the user can recognize an increase in the word count by looking at the image information generated corresponding to the parameter. In this way, it is possible to further gain the sense of achievement for inputting the voice. As a result, it is possible to acquire the user's voice preferably.

The image information transmitted from the voice synthesis model generation device 3 to the mobile communication terminal device 2 is information to display the character image and the character image output to the user changes, for example, becomes larger, corresponding to the parameter, therefore, it is possible to visually impress the user better than a case where values and the like are displayed as the image. In this way, it is possible for the user to further gain a sense of achievement, and the user's motivation to input the voice further improves. As a result, it is possible to acquire the user's voice preferably.

Since the voice synthesis model generation portion 301 generates the voice synthesis model for each user, it is possible to generate the voice synthesis model corresponding to each user and to use the voice synthesis model by individuals.

A voice characteristic amount is context data in which the voice is labeled in a voice unit and data about a voice wave that shows characteristics of the voice (logarithmic fundamental frequency and the mel-cepstrum). Accordingly, it is possible to reliably generate the voice synthesis model.

Since the voice is acquired by the mobile communication terminal device 2, a facility such as a studio is unnecessary and it is possible to easily acquire the voice. Moreover, unlike a case that the voice synthesis model is generated from the voice transmitted from the mobile communication terminal device 2, the mobile communication terminal device 2 extracts the characteristic amount necessary to generate the voice synthesis model and transmits it, therefore, it is possible to generate the voice synthesis model with higher accuracy than a case that the voice synthesis model is generated by using the voice deteriorated through a communication path.

The present invention is not limited to the above embodiment. In the above embodiment, HMM is used to generate the voice synthesis model and learning is performed, but other algorism may be used to generate the voice synthesis model.

In the above embodiment, the voice characteristic amount is extracted by the characteristic amount extraction portion 201 of the mobile communication terminal device 2, and the characteristic amount is transmitted to the voice synthesis model generation device 3, but the voice input in the voice input portion 200 may be transmitted as voice information (for example, coded voice such as AAC and AMR) to the voice synthesis model generation device 3. In such a case, the characteristic amount is extracted in the voice synthesis model generation device 3.

In the above embodiment, based on the level corresponding to the parameter that corresponds to the accumulated word count of the words that are held in the word database 305, the image information generation portion 307 generates the image information, but the method for generating the image information is not limited thereto. For example, a database is provided to hold data for configuring a size, a character or the like of a character image C, and, when voice such as “Thank you” is input by a user, the image information may be generated in a way such that 1 is added to data indicating the size and 1 is added to data showing a gentle character, in accordance with a given rule.

In the above embodiment, the image information is information for displaying a character image, but it may be information for displaying an object, such as a graph, a value, an automobile and the like. In a case of a graph, it may be information for displaying the accumulated word count. In a case of an object such as an automobile, it may be information and the like for changing a shape with a given word count achieved.

In the above embodiment, the image information is display data for displaying the character image, but it is not necessarily the display data, and it may only be data for generating an image in the mobile communication terminal device 2. For example, the voice synthesis model generation device 3 generates and transmits image information for generating an image based on the parameter output from the parameter generation portion 306, and the mobile communication terminal device 2 that receives the image information may generate a character image. Specifically, the image information generated in the voice synthesis model generation device 3 is a parameter indicating a face size or a skin color of the character image that is set in advance.

By way of transmitting the parameter output from the parameter generation portion 306 in the voice synthesis model generation device 3 as image information, the mobile communication terminal device 2 may generate a character image based on the parameter. In such a case, the mobile communication terminal device 2 holds, corresponding to the above parameter, information about which character image it generates (for example, information shown in FIG. 6).

By way of transmitting the accumulated word count of the word data held in the word database 305 of the voice synthesis model generation device 3 as image information, the mobile communication terminal device 2 may generate the character image based on the image information. In such a case, the mobile communication terminal device 2 generates a parameter from the accumulated word count and holds information about which character image it generates (for example, information shown in FIG. 6), corresponding to the parameter.

In the above embodiment, based on the word count in each word category held in the word database 305, the request information generation portion 308 generates the request information, but the word may be requested in sequence from a database where a request word is stored in advance.

In the above embodiment, the text data acquisition portion 202 is provided in the mobile communication terminal device 2, but it may be provided in the voice synthesis model generation device 3. Furthermore, acquisition of the text data may be carried out by a server device capable of transmitting and receiving information by mobile communication, instead of being carried out by the mobile communication terminal device 2 itself. In such a case, the mobile communication terminal device 2 transmits the characteristic amount extracted by the characteristic amount extraction portion 201 to the server device and, upon transmission of the characteristic amount, the text data acquired based on the characteristic amount is transmitted from the server device.

In the above embodiment, the text data is acquired by the text data acquisition portion 202, but it may be input by a user himself after the user inputs the voice. Furthermore, it may be acquired from the text data included in the request information.

In the above embodiment, the text data acquisition portion 202 acquires the text data without asking confirmation from the user, but it may be configured in a way that the acquired text data is displayed to the user once and it is acquired after a confirm key, for example, is pressed by the user.

In the above embodiment, the voice synthesis model generation system 1 is configured by the mobile communication terminal device 2 and the voice synthesis model generation device 3, but it may be configured only by the voice synthesis model generation device 3. In such a case, a voice input portion and the like are provided in the voice synthesis model generation device 3.

### DESCRIPTION OF THE SYMBOLS

1 voice synthesis model generation system
2 mobile communication terminal device (communication terminal device)
3 voice synthesis model generation device
200 voice input portion (voice input means)
201 characteristic amount extraction portion (characteristic amount extraction means)
202 text data acquisition portion (text data acquisition means)
203 learning information transmission portion (learning information transmission means)
204 reception portion (image information reception means)
205 display portion (display means)
300 learning information acquisition portion (learning information acquisition means)
301 voice synthesis model generation portion (voice synthesis model generation means)
304 word extraction portion (word extraction means)
306 parameter generation portion (parameter generation means)
307 image information generation portion (image information generation means)
308 request information generation portion (request information generation means)
309 information output portion (image information output means)
C, C1, C2 character image

1. A voice synthesis model generation device comprising:
learning information acquisition means for acquiring text data corresponding to a characteristic amount of a user's voice and text data corresponding to the voice;
voice synthesis model generation means for generating a voice synthesis model by carrying out learning based on the characteristic amount and the text data that are acquired by the learning information acquisition means;
parameter generation means for generating a parameter indicating a degree of learning in terms of the voice synthesis model generated by the voice synthesis model generation means;
image information generation means for generating image information for displaying an image to a user corresponding to the parameter generated by the parameter generation means; and
image information output means for outputting the image information generated by the image information generation means.

2. The voice synthesis model generation device according to claim 1, further comprising:
request information generation means for generating and outputting request information that makes the user input the voice based on the parameter generated by the parameter generation means.

3. The voice synthesis model generation device according to claim 1, further comprising:
word extraction means for extracting a word from the text data acquired by the learning information acquisition means, wherein
the parameter generation means generates the parameter indicating the degree of learning in terms of the voice synthesis model corresponding to an accumulated word count of the word extracted by the word extraction means.

4. The voice synthesis model generation device according to claim 1, wherein the image information is information for displaying a character image.

5. The voice synthesis model generation device according to claim 1, wherein the voice synthesis model generation means generates the voice synthesis model for each user.

6. The voice synthesis model generation device according to claim 1, wherein the characteristic amount is context data in which the voice is labeled in a voice unit and data about a voice wave that shows characteristics of the voice.

7. A voice synthesis model generation system comprising:
a communication terminal device with a communication function; and
a voice synthesis model generation device capable of communicating with the communication terminal device;
the communication terminal device including:
voice input means for inputting a user's voice;
learning information transmission means for transmitting voice information composed of the voice input with the voice input means and a characteristic amount of the voice, and text data corresponding to the voice, to the voice synthesis model generation device;
image information reception means for receiving image information for displaying an image to a user from the voice synthesis model generation device, once the learning information transmission means transmits the voice information and the text data; and
display means for displaying the image information received by the image information reception means;
the voice synthesis model generation device including:
learning information acquisition means for acquiring the characteristic amount of the voice by receiving the voice information transmitted from the communication terminal device, and for acquiring the text data by receiving the text data transmitted by the communication terminal device;
voice synthesis model generation means for generating the voice synthesis model by carrying out learning based on the characteristic amount and the text data that are acquired by the learning information acquisition means;
parameter generation means for generating a parameter indicating a degree of learning in terms of the voice synthesis model generated by the voice synthesis model generation means;
image information generation means for generating the image information corresponding to the parameter generated by the parameter generation means; and
image information output means for transmitting the Image information generated by the image information generation means to the communication terminal device.

8. The voice synthesis model generation system according to claim 7, wherein the communication terminal device further includes characteristic amount extraction means for extracting the characteristic amount of the voice from the voice input with the voice input means.

9. The voice synthesis model generation system according to claim 7, further comprising:
text data acquisition means for acquiring text data corresponding to the voice from the voice input with the voice input means.

10. A communication terminal device with a communication function comprising:
voice input means for inputting a user's voice;
characteristic amount extraction means for extracting a characteristic amount of the voice from the voice input with the voice input means;
text data acquisition means for acquiring text data corresponding to the voice;
learning information transmission means for transmitting the voice characteristic amount extracted by the characteristic amount extraction means and the text data acquired by the text data acquisition means, to a voice synthesis model generation device capable of communicating with the communication terminal device;
image information reception means for receiving image information for displaying an image to the user from the voice synthesis model generation device, once the learning information transmission means transmits the characteristic amount and the text data; and
display means for displaying the image information received by the image information reception means.

11. A method for generating tip voice synthesis model comprising:
a learning information acquisition step of acquiring a characteristic amount of a user's voice and text data of the voice;
a voice synthesis model generation step of generating a voice synthesis model by carrying out learning based on the characteristic amount and the text data that are acquired in the learning information acquisition step;
a parameter generation step of generating a parameter indicating a degree of learning in terms of the voice synthesis model generated in the voice synthesis model generation step;
an image information generation step of generating image information for displaying, to a user, an image corresponding to the parameter generated in the parameter generation step; and
an image information output step of outputting the image information generated in the image information generation step.

12. A method for generating a voice synthesis model that is a method performed by a voice synthesis model generation system including a communication terminal device with a communication function and a voice synthesis model generation device capable of communicating with the communication terminal device,
the communication terminal device comprising:
a voice input step of inputting a user's voice;
a learning information transmission step of transmitting voice information composed of the voice input in the voice input step or a characteristic amount of the voice, and text data corresponding to the voice, to the voice synthesis model generation device;
an image information reception step of receiving image information for displaying an image to the user from the voice synthesis model generation device, once the voice information and the text data are transmitted in the learning information transmission step; and
a display step of displaying the image information received in the image information reception step;
the voice synthesis model generation device comprising:
a learning information acquisition step of acquiring the characteristic amount of voice by receiving the voice information transmitted from the communication terminal device, and of acquiring the text data by receiving the text data transmitted from the communication terminal device;
a voice synthesis model generation step of generating a voice synthesis model by carrying out learning based on the characteristic amount and the text data acquired in the learning information acquisition step;
a parameter generation step of generating a parameter indicating a degree of learning in terms of the voice synthesis model generated in the voice synthesis model generation step;
an image information generation step of generating the image information corresponding to the parameter generated in the parameter generation step; and
an image information output step of transmitting the image information generated in the image information generation step to the communication terminal device.

13. A method for generating a voice synthesis model that is a method performed by a communication terminal device with a communication function, the method comprising:
a voice input step of inputting a user's voice;
a characteristic amount extraction step of extracting a characteristic amount of the voice from the voice input in the voice input step;
a text data acquisition step of acquiring text data corresponding to the voice;
a learning information transmission step of transmitting the voice characteristic amount extracted in the characteristic amount extraction step and the text data acquired in the text data acquisition step, to a voice synthesis model generation device capable of communicating with the communication terminal device;
an image information reception step of receiving image information for displaying an image to the user from the voice synthesis model generation device, once the characteristic amount and the text data are transmitted in the learning information transmission step; and
a display step of displaying the image information received in the image information reception step.
